(19) United States
(12) Patent Application Publication
(10) Pub. No.: US 2013/0340856 A1
(43) Pub. Date: Dec. 26, 2013

(54) CHAMBER DEVICE FOR ABSORBING NOISE IN FLOAT VALVE

(71) Applicant: Yoichi HIRANO, Hiroshima (JP)

(72) Inventor: Yoichi HIRANO, Hiroshima (JP)

(73) Assignee: NIFCO INC., Yokohama-shi (JP)

(21) Appl. No.: 13/529,247

(22) Filed: Jun. 21, 2012

(51) Int. Cl. F16K 47/02

(52) U.S. Cl. 137/375

(57) ABSTRACT

A chamber device is designed to be attached to a float valve for reducing noise generated by the float valve. The chamber device includes an upper plate having a top opening portion to be attached to the float valve, a bottom plate facing the upper plate, a side wall extending between the upper plate and the bottom plate, and an introduction passage formed on the side wall for allowing a fuel to flow into the float valve. A space is defined by the upper plate, and the bottom plate and the side wall so as to absorb the noise in the float valve.

### FIELD OF THE INVENTION

The present invention relates to a chamber device which is attached to a float valve for a vehicle, and the like, and functions so as to absorb a noise generated by a float in the float valve.

### BACKGROUND ART

As a float valve having a float for preventing a fuel liquid from flowing into a valve chamber through an air hole, there is one shown in Patent Document 1.

A basic structure of the float valve will be explained below. The float valve comprises a float, a casing body, a housing case, an inner lid body, and a lid body. A valve chamber is formed in a space defined between the inner lid body and the casing body, and the float is stored therein. The lid body includes a connecting projection having an opening toward a side of a canister, and the casing body includes an introducing projection having an opening toward an inside of a fuel tank. The float stored in the valve chamber is ascended to close or descended to open the connecting projection of the lid body so as to control a fuel liquid level in the fuel tank. The lid body is fixed to an upper part of the casing body. The float valve prevents a fuel liquid from flowing into the valve chamber thorough the air hole.

However, in such float valve as shown in Patent Document 1, when the float is descended, a knocking noise is generated by the float. Also, the knocking noise reverberates in the valve chamber because the introduction passage has the opening toward the inside of the tank. Further, the knocking noise is caused by a liquid sloshing and the like, when the vehicle runs.

Accordingly, the float valve shown in Patent Document 1 emits the noise and the noise reverberates in the valve chamber.

### PRIOR ART DOCUMENT

Patent Document 1: Japanese Patent Publication No. 2010-105468

### SUMMARY OF THE INVENTION

The present invention has been made to obviate the problems in the float valve, and an object of the invention is to provide a chamber device attached to the float valve to absorb a noise generated by a float in the float valve.

Further objects and advantages of the invention will be apparent from the following description of the invention.

In order to achieve the above-mentioned object, in the present invention, a chamber device attached to a float valve is provided so as to absorb a noise generated by a float in the float valve. In the present invention, a chamber device comprises an upper plate having a top opening portion to be attached to the float valve; a bottom plate facing the upper plate; a side wall extending between the upper plate and the bottom plate; and an introducing portion formed on the side wall for flowing a fuel into the float valve. Then, a space is defined by the upper plate, and the bottom plate and the side wall.

The float valve having the float as disclosed in the Patent Document 1 can be used in the invention. The float valve may have a fixing member to engage the chamber device therewith.

As describe above, the side wall extends between the upper plate and the bottom plate. In particular, the side wall and the upper plate form a case portion, and the bottom plate forms a cap portion. The case portion comprising the upper plate and the side wall is covered by the cap portion comprising the bottom plate. Thus, a space is defined by the upper plate, and the bottom plate and the side wall.

Therefore, when the chamber device attached to the valve device, such as the Patent Document 1, an opening of an introducing portion is substantially covered by the cap portion. As a result, a noise caused by the float is not reverberated in the valve chamber.

Further, the upper plate has an upper plate flange formed around the top opening portion to be attached to the float valve, and the top opening portion is deviated from the center of the upper plate. Therefore, the chamber device more effectively absorbs the noise.

### BRIEF DESCRIPTION OF THE DRAWINGS

FIG. 1 is a front view of a chamber device, in a used state, in accordance with an embodiment.

FIG. 2 is a perspective view of an upper plate and a side wall of the chamber device.

FIG. 3 is a front view thereof.

FIG. 4 is a perspective view of a bottom plate of the chamber device.

FIG. 5 is a front view thereof.

FIG. 6 is a perspective view of the chamber device in a state wherein the side wall and bottom plate are engaged.

FIG. 7 is a top view thereof.

FIG. 8 is a cross-sectional view thereof taken along line 8-8 in FIG. 7.

FIG. 9 is a perspective view of a reinforcement member in a used state.

### DETAILED DESCRIPTION OF DISCLOSED

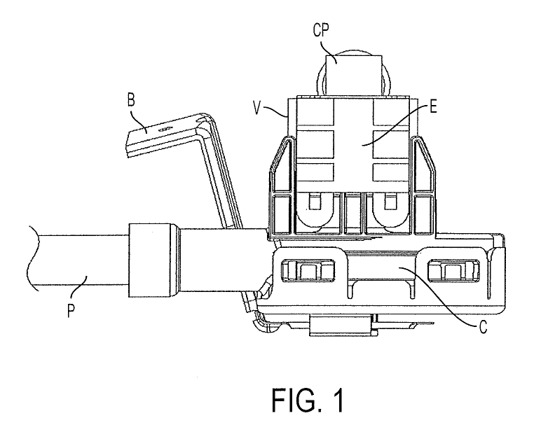

Hereinafter, an embodiment of the present invention will be explained with reference to FIGS. 1 to 9. Typically, a chamber device C according to the embodiment is attached to a float valve V so as to absorb a noise in the float valve V.

In FIG. 1, the float valve has a float (not shown), a valve bottom opening (not shown), a connecting projection CP, and a fixing member E; and the chamber device C is attached to the float valve V through the fixing member E. Also, a bracket B is set in the chamber device C, and a pipe P is connected to the chamber device C. The bracket B is set in the chamber device C so as to fix the float valve V with the chamber device C around an upper side of the tank (not shown), and the pipe P is connected to the chamber device C to introduce a fuel liquid into the float valve V.

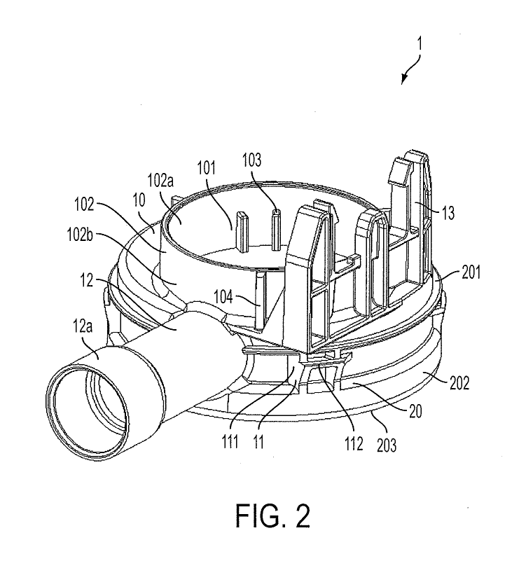

The case portion 1 comprising the upper plate 10 and the side wall 20, will be explained below with reference to FIGS. 2, 3, 7 and 8.

In FIG. 2, the upper plate 10 has a top opening portion 101 and an upper plate flange 102 formed around the top opening portion 101 to be attached to the float valve V therethrough.

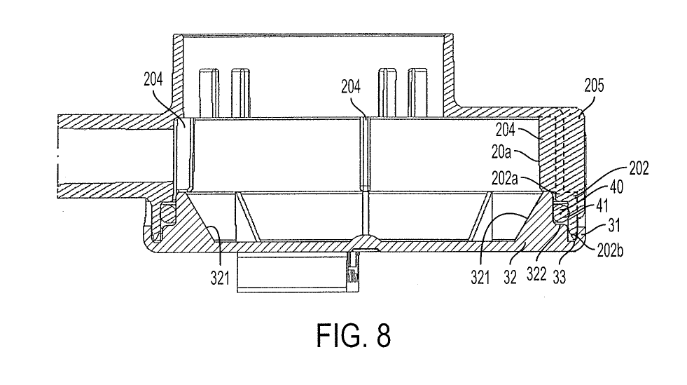

The side wall 20 extends from the upper plate 10. The side wall 20 has a side wall top flange 201 formed around a top portion thereof and a side wall bottom flange 202 formed around a bottom portion thereof. A bottom opening portion 203 is defined by the side wall bottom flange 202, and the bottom opening portion 203 is covered by a bottom plate 20 (a cap member 2) as explained later. A diameter of the side wall top flange 201 is approximately same as that of the side wall bottom flange 202. A plurality of side wall inside ribs 204 is formed on an inner surface of the side wall 20 as explained in FIG. 8.

A side wall engaging member 11 is integrally formed between the side wall top flange 201 and the side wall bottom flange 202. The side wall engaging member 11 includes a base portion 111 and a claw portion 112. The claw portion 112 is formed on the base portion 111 and projects outwardly from the base portion 111 so as to engage the bottom plate 20 as explained later.

The introducing portion or projection 12 has a pipe attachment portion 12a to connect the pipe P, and the introducing projection 12 and the pipe P constitute a passage to allow the fuel liquid to flow into the float valve V. The introducing projection 12 projects outwardly from the side wall 20 and is disposed on the side wall 20 close to the top opening portion 101.

A plurality of inside ribs 103 is formed on an inner surface 102a of the upper plate flange 102. The plurality of inside ribs 103 respectively projects inwardly from the inner surface 102a. Also, a plurality of outside ribs 104 is formed on an outer surface 102b of the upper plate flange 102. The plurality of outside ribs 104 respectively projects outwardly from the outer surface 102b.

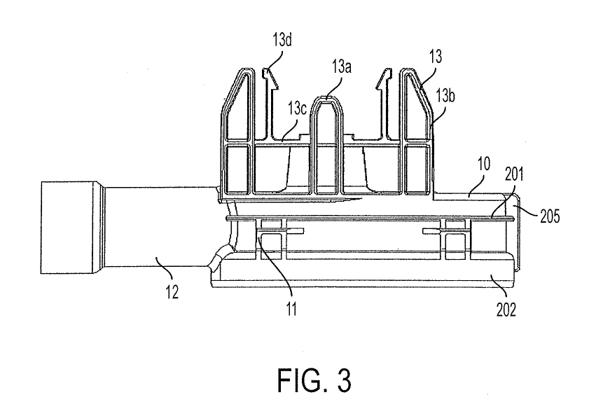

In FIG. 3, a stopper portion 205 is formed on the side wall and is disposed on a symmetric position relative to the introduction passage 12. The stopper portion 205 projects outwardly from the side wall 20 and extends from the upper plate 10 to the side wall bottom flange 202 over the side wall top flange 201. The stopper portion 205 engages the bottom plate 20 so as to prevent the case member 10 from rotating on the bottom plate 30 as explained later.

The valve engaging member 13 is attached on the side wall 20. The valve engaging member 13 comprises a base portion 13a formed on a center thereof, a side support portion 13b formed on both sides thereof, an arm portion 13c passing through the base portion 13a between the side support portions 13b, and a hook portion 13d provided between the base portion 13a and side support portion 13b on the arm portion 13c. A top portion of the base portion 13a is rounded and a top portion of the side support portion 13b is tapered. A length of the base portion 13a is shorter than that of the side support portion 13b. Also, a top portion of the hook portion 13d is approximately shaped as an arrow. Therefore, the hook portion lid engages the fixing member E of the float valve V so as to pinch the engaged member E at an inside thereof, and the support portion 13b supports an outer surface of the float valve V; thereby, the float valve V is tightly engaged with the case portion 1.

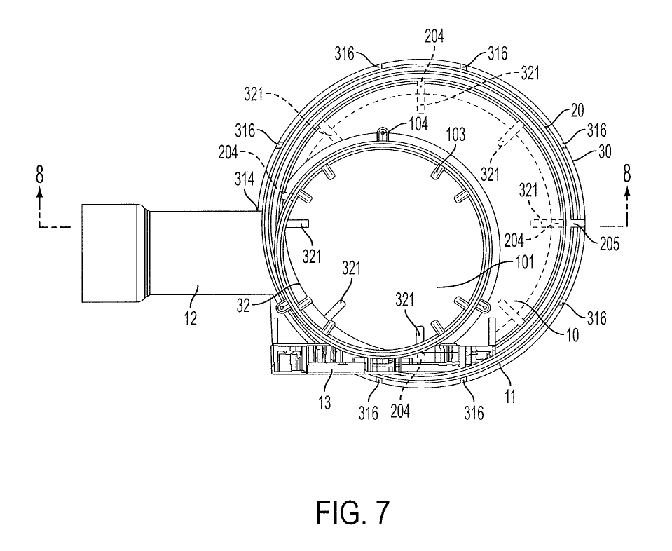

As shown in FIG. 7, the top opening portion 101 is deviated from a center of the upper plate 10. Therefore, the chamber device C effectively absorbs the noise in the fuel valve V such as a knocking noise generated by the float.

The plurality of inside ribs 103 is arranged in regular intervals and configured to support the fuel valve V in the top opening portion 101 such that the fuel valve V is stably fixed therein. The plurality of outside ribs 104 is arranged in wider intervals than that of the plurality of inside ribs 103. Also, the plurality of side wall inside ribs 204 is arranged in regular intervals, and the side wall inside ribs 204 face each other.

As shown in FIG. 8, an inside wall 20a has a uniform thickness, and an inner diameter of the side wall bottom flange 202 is larger than that of the inside wall 20a. Thus, a shoulder portion 202a is formed therebetween. A tapered portion 202b is formed on a bottom portion of the side wall bottom flange 202 so as to engage the bottom plate 30 as explained later. Also, the plurality of side wall inside ribs 204 is formed on an inside wall 20a of the side wall 20, and the plurality of side wall inside ribs contacts the bottom plate 30 on an inside of the side wall 20 as explained later.

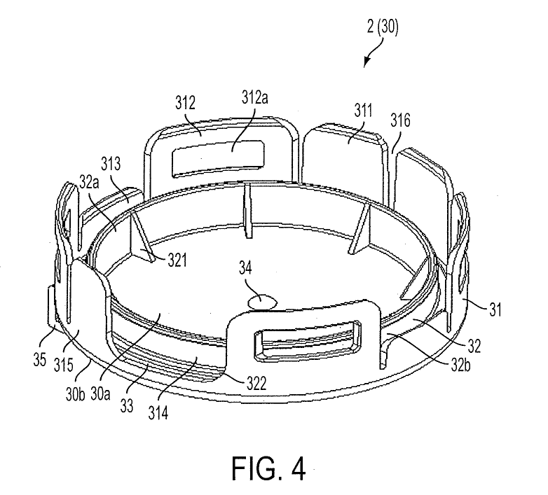

The cap portion 2 comprising the bottom plate 30 will be explained below with FIGS. 4, 5 and 8. The bottom opening portion of the side wall 20 is covered by the bottom plate 30.

In FIG. 4, the bottom plate 30 includes an outer annular projecting portion 31 formed along an outer periphery of the bottom plate 30, an inner annular projecting annular portion 32 formed on an inside of the outer projecting annular portion 31, a groove 33 formed between the outer annular projecting portion 31 and the inner annular projecting portion 32, a center convex formed on a center of the bottom plate 30, and a bracket attachment 35 formed on a back side surface 30b of the bottom plate 30.

The outer annular projecting portion 31 projects upwardly from the bottom surface 30a of the bottom plate 30. The outer annular projecting portion 31 includes a plurality of arc-shape panels 311, hole panels 312, cutout panels 313, an introducing hole 314, and a hole side panel 315. The introducing hole 314 and the hole side panel 315 are disposed next to each other, and a pair of arc-shape panels 311 faces the introducing hole 314 and the hole side panel 315. The hole panels 312 are respectively disposed next to the introducing projection hole 314 and the hole side panel 315, and both sides of the pair of arc-shape panels 311; and the cutout panel 313 are disposed between the hole panels 312. Accordingly, the hole panel 312 and the cutout panel 313 are symmetrically disposed relative to the center of the bottom plate 30.

The hole panel 312 has a window hole 312a such that the side wall engaging member 11 engages therewith, and the introducing hole 314 is formed such that the introducing projection 12 passes through the outer annular projecting portion 31. A plurality of slits 316 is provided between each of the above-mentioned panels, which are the arc-like panels 311, the hole panels 312, cutout panels 313 and the hole side panel 315. The stopper portion 205 is stuck into the slit 316, which is disposed on a symmetric position relative to the introducing projection 12, so as to prevent the side wall 20 from rotating on the bottom plate 30.

The inner annular projecting portion 32 projects upwardly from the bottom surface 30a of the bottom plate 30 and is coaxially formed with the outer annular projection portion 31. A plurality of inner ribs 321 is formed on an inner surface 32a of the inner projecting portion 32. The plurality of inner ribs 321 projects inwardly from an inner surface 32a of the inner annular projecting portion 32 and the plurality of inner ribs 321 is disposed in regular intervals.

The inner annular projecting portion 32 has an outer flange 322 formed along an outer periphery thereof. The outer flange 322 projects outwardly from an outer surface 32b of the inner annular projecting portion 32.

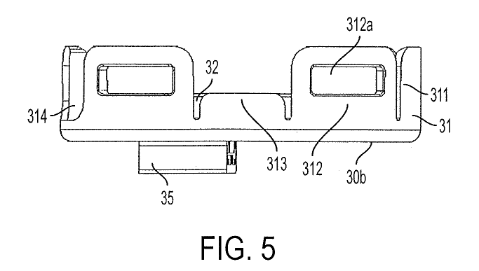

As shown in FIG. 5, a bracket attachment 35 is formed at a back side surface 30b of the bottom plate 20 and disposed on a position deviated from a center of the bottom plate 30 such that the bracket B is set therein.

In FIG. 8, the groove 33 is formed between the outer annular projecting portion 31 and the inner annular projecting portion 32 so as to set the side wall 20 therein. Particularly, the groove 33 is formed at a bottom portion between the outer flange 322 of the inner annular projecting portion 32 and an inner surface 31b of the outer annular projecting portion 31.

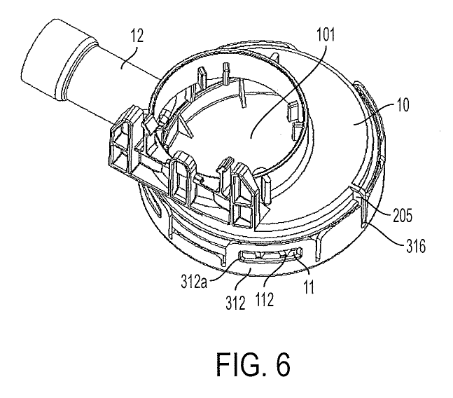

The chamber device C in a state wherein the case portion 1 engages the cap portion 2 will be explained below with FIGS. 6, and 8. When the case portion 1 and the cap portion 2 are engaged, the case portion 1 is covered by the cap portion 2; thereby, the opening of the float valve V is substantially covered by the bottom plate. Thus, the space is formed by the upper plate 10, and the bottom plate 30 and the side wall 20 so as to absorb a noise in the float valve.

As shown in FIG. 6, the claw portion 112 of the side wall engaging member 11 in the case portion 1 is set in the window hole 312a of the hole panel 312 in the cap portion 2. Also, the stopper portion 205 of the case portion 1 enters into the slit 316 of the cap portion 2 so as to prevent the case portion 1 form rotating on the cap portion 2.

In FIG. 7, the introducing projection 12 of the case portion is set into the introducing hole 314 of the cap portion 2. The side wall 20 engages coaxially the bottom plate 30. Therefore, the case portion 1 and the cap portion 2 are stably engaged.

In FIG. 8, the plurality of side wall inside ribs 204 contacts a top portion of the inner projecting portion 32 on the inside thereof. The tapered portion 202b of the side wall 20 is set between the outer flange 322 of the inner annular projecting portion 32 and the inner surface 31a of the outer annular projecting portion 31, and faces the groove 33. Thereby, an O-ring space 40 is defined between the shoulder portion 202a of the side wall 20 and the outer flange 322 of the inner annular projecting portion 32 so as to set an O-ring 41 therein.

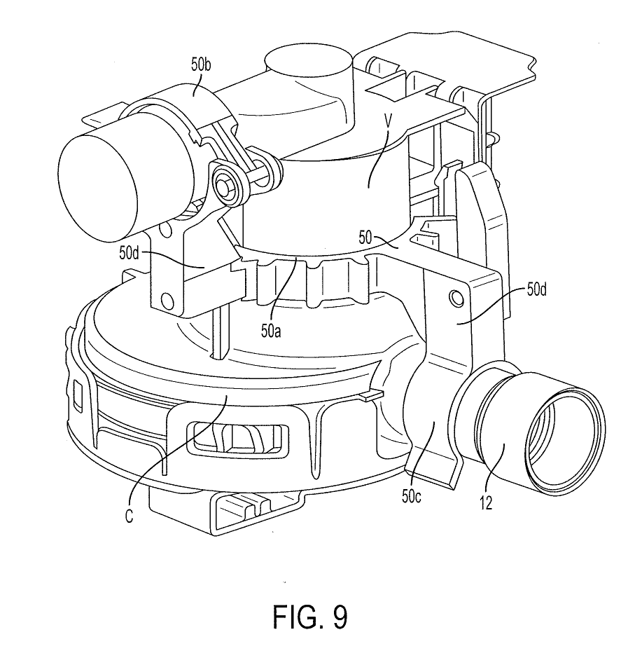

A reinforce member 50 will be explained below with reference to FIG. 9. The reinforcement member 50 sets the float valve V and the chamber device C so as to reinforce an engagement between the float valve V and the chamber device C.

In FIG. 9, the reinforce member 50 comprises a base ring portion 50a to be attached to the float valve V, an upper ring portion 50b engaged with a connecting projection of the float valve V, an open ring portion 50c engaged with the introducing projection 12 of the chamber device C, and arm portions 50d extending from the base ring portion 50a, one of the arm portions connecting the upper ring portion 50b and other of the arm portion connecting the opened ring portion 50c. The upper ring portion is formed with an openable and closable ring to engage the connecting projection CP of the float valve V, and the open ring portion is formed with an elastic material to engage the introduction passage 12.

While the invention has been explained with reference to the specific embodiments of the invention, the explanation is illustrative and the invention is limited only by the appended claims.

What is claimed is:

1. A chamber device adapted to be attached to a float valve comprising:
an upper plate having a top opening portion to be attached to the float valve;
a bottom plate facing the upper plate;
a side wall extending between the upper plate and the bottom plate; and
an introducing portion formed on the side wall for flowing a fuel liquid into the float valve,
wherein a space is defined by the upper plate, the bottom plate and the side wall so as to absorb a noise in the float valve.

2. The chamber device according to claim 1, wherein the upper plate has an upper plate flange formed around the top opening portion to be attached to the float valve.

3. The chamber device according to claim 2, wherein the top opening portion is deviated from a center of the upper plate.

4. The chamber device according to claim 3, wherein the side wall has an engaging portion, and the bottom plate has an engaged portion, the engaging portion and the engaged portion being engaged together such that the side wall and the bottom plate are integrated.

5. The chamber device according to claim 4, wherein the bottom plate has a first annular projecting portion formed on an outer side thereof, a second annular projecting portion formed on an inner side of the first annular projecting portion, and a groove formed between the first annular projecting portion and the second projecting annular portion; and the side wall is fitted in the groove.

6. The chamber device according to claim 5, wherein the bottom plate has a bracket engaging member formed on a back side thereof such that a bracket is set into the bracket engaging member to fix the chamber device.

7. The chamber device according to claim 5, wherein an 0-ring space is defined between the side wall and the second annular projecting portion such that an 0-ring is fitted therein to seal the side wall and the bottom plate.

8. The chamber device according to claim 9, wherein the side wall has a stopper portion projecting outwardly therefrom, and the first projecting portion has a plurality of panels and a plurality of slits provided between the plurality of panels; and
the stopper portion enters into the slit disposed relative to the introducing portion so as to prevent the side wall rotating on the bottom plate.

9. A combination comprising:
the chamber device according to claim 1; and
a float valve having a bottom opening, the bottom opening covered by the bottom plate.

10. The combination according to claim 9, wherein the chamber device further comprises a valve engaging member attached on the side wall, and the float valve further comprises a fixing member, the valve engaging member and the fixing member are engaged together such that the chamber device and the float valve are integrated.

11. The combination according to claim 10, wherein the float valve further comprises a connecting projection; and
the chamber device further comprises a reinforce member having a base ring portion to be attached to the float valve, an upper ring portion engaged with the connecting projection, an open ring portion engaged with the introducing portion, and arm portions extending from the base ring portion and having a first arm portion connecting the upper ring portion and a second arm portion connecting the open ring portion.
